(19) United States
(12) Patent Application Publication
(10) Pub. No.: US 2015/0208595 A1
(43) Pub. Date: Jul. 30, 2015

(54) Water Storage Devices and Apparatuses Therefor

(71) Applicant: Bjorn WOOD, Putney, London (GB)

(72) Inventor: Bjorn Wood, London (GB)

(21) Appl. No.: 14/426,560

(22) PCT Filed: Sep. 9, 2013
(86) PCT No.: PCT/GB2013/052357

§ 371 Date: Mar. 6, 2015

(30) Foreign Application Priority Data
Sep. 7, 2012 (GB) 1215981.0

(51) Int. Cl. A01G 27/00; A01G 9/02

(52) U.S. Cl. CPC A01G 27/005; A01G 9/02

(57) ABSTRACT

A water butt comprises an interior volume for storing liquid; a container suitable for holding one or more plants, disposed on a side of the water butt; and a duct coupled between the interior volume of the water butt and the container, and configured to allow passage of liquid from the interior volume to the container. An apparatus mountable to a water management device for receiving liquid therefrom, comprises a container suitable for holding one or more plants; and a duct coupled to the container, and configured to allow passage of liquid from the water management device to the container.

### FIELD OF THE INVENTION

This invention relates to improvements in water storage devices and apparatuses therefor. In particular, this invention relates to an apparatus having a container mountable to or disposed on the side of a water butt for receiving liquid therefrom and an apparatus mountable to the side of a water butt for storing liquid separately from the primary liquid store.

### BACKGROUND OF THE INVENTION

It is becoming increasingly common for gardens and allotments to have access to one or more water butts for providing a store of liquid which is not dependent on the mains water supply. Water shortages and temporary prohibitions on the use of mains water for watering garden plants means that gardeners are becoming increasingly reliant on water butts to provide a reliable store of water.

Water butts, which are also known as water barrels or rain barrels, operate by collecting rainwater in a suitably sized container. Typically, rainwater is collected from the roof of a building and channelled, via guttering and drainpipes, into a water butt for storage therein.

Conventionally, a tap is provided in the water butt for gaining access to the store of water. Since pumps are not usually employed, the tap is typically located as low as practicable in the water butt, so as to enable drainage of substantially all of the water stored therein. Often, a water butt will be slightly raised up above grounds level sufficient for providing space for a bucket or watering can to be placed underneath the tap for convenient filling.

Due to their size and form, water butts are generally unattractive and can be an unsightly distraction in an otherwise picturesque garden or allotment environment. This is undesirable.

One problem gardeners often face is how to keep plants watered during extended periods of absence, for example during a vacation. Typically, plants will wilt and die if they are not watered for more than a couple of days, often less. As described below, some solutions to this problem have been devised, but all are unsatisfactory.

One solution is to place a pouch or container of water in the soil surrounding a plant, the pouch or container having a very small hole in a lower portion thereof which permits a steady supply of water to leak out into the surrounding soil. These devices can provide water to the plants for a period of several days or even a week. Unfortunately, the pouches cannot be refilled, once empty, and thus may only provide a temporary supply of water. Moreover, one pouch must be provided for each plant, which can become very expensive.

Another solution is to use a so-called “leaky hose”. This is a hose which has a plurality of very small holes provided along its length. The hose may be connected to a mains water tap, or even a water butt, to supply a steady stream of water over an area of land. However, it is often difficult to gain access to a mains water tap, particularly in an allotment; many properties do not have an outside tap. In any case, gardeners are often reluctant to leave a mains water tap open for extended periods of time in case of failure, and therefore flood. Moreover, hoses may not be used during a hosepipe ban.

A problem associated with attaching a hose to a water butt is that the water pressure and flow rate is dependent on the quantity of water stored in the water butt, which may become low over time, particularly during periods of low rainfall (which is often the time automated watering devices such as those described above are needed most). Thus, as the quantity of water stored in the water butt is depleted, the water butt ceases to be able to supply water to plants above a particular height, or through a particular length of hose, due to the resistance to flow. Without raising the entire water butt higher than all plants which are to be watered (which is often impractical), it has been hitherto very difficult to use a water butt to provide a reliable water source during extended periods of absence.

### SUMMARY OF THE INVENTION

The present invention provides solutions to the aforementioned problems.

In a first aspect of the present invention, there is provided an apparatus mountable to a wall of a water management device for receiving liquid therefrom, the apparatus comprising a container suitable for holding one or more plants; and a duct, coupled to the container, and configured to allow passage of liquid from the water management device to the container.

In a preferred embodiment, the water management device is a water butt. However, other water management devices such as liquid containers other than water butts, or liquid transport pipes such as rainwater drainpipes, rainwater downpipes, waste pipes, sewerage pipes and so on are also envisaged. For the remainder of the description, the preferred embodiment of a water butt will be referred to. However, it will be appreciated that an apparatus according to the first aspect of the invention is not limited to use only with water butts.

When the water management device is a water butt, it is preferred that the apparatus is mountable to a side of the water but.

The apparatus provides an improved device for growing or storing plants which enables the plants to receive water from the water butt. Plants may receive a supply of water from the water butt, which may last for a prolonged period of time. Moreover, by placing plants in containers around the water butt, they may provide a decorative feature which improves the attractiveness of the water butt.

The apparatus may comprise one container, or it may comprise a plurality of containers, each suitable for holding one or more plants. Moreover, the apparatus may comprise one duct, or it may comprise a plurality of ducts. One duct may be coupled to a plurality of containers, via a plurality of channels, for example. Conversely one container may be coupled to a plurality of (i.e. two or more) ducts. In one optional arrangement, each container is coupled to a respective duct. Preferably, the duct or ducts comprises on or more a tubes.

Preferably, the further comprising an auxiliary liquid reservoir mountable to a side (e.g. an inside) of the water butt and configured to provide a store of liquid. In this case, the aforementioned duct or ducts, may be coupled to the auxiliary liquid reservoir and configured to allow passage of liquid from the auxiliary liquid reservoir to the container or containers.

When the water management device is a water butt, it is preferred that the auxiliary liquid reservoir provides a separate store of liquid from the primary liquid store of the water butt.

The provision of an auxiliary liquid store means that a store of water may be held separately from the primary store of the water butt; for example higher than the primary liquid store. Thus, as the primary liquid store becomes depleted, the auxiliary liquid store maintains a supply of liquid for use at a given location, such as a higher location than the primary liquid store, for example to provide a longer lasting supply of water for one or more preferred plants, or to provide a supply of water for plants at a higher location than those watered by the primary liquid store. The separate store may also be used for delivering different kinds of liquid from the primary store, such as liquid feed or water with particular nutrients dissolved therein.

One or more metering devices may be provided in the duct or ducts for restricting passage of liquid from the water butt to the container. The metering device may be manual or automatic. It may comprise a valve, or a semi-permeable membrane, or a very small aperture, for example.

The apparatus may be provided with mounting means adapted to mount the container to the water butt. The mounting means may be adapted to hook over a lip of the water butt for ease of installation.

In a second aspect of the present invention, there is provided a water butt comprising an interior volume for storing liquid; a container suitable for holding one or more plants, disposed on a side of the water butt; and a duct coupled between the interior volume of the water butt and the container, and configured to allow passage of liquid from the interior volume to the container.

The same or equivalent features mentioned above in respect of the first aspect may be provided on the second aspect to similar or equivalent effect.

Moreover, the container for plants and auxiliary liquid reservoir of the water butt may be integral with or removably connectable to the water butt.

In a third aspect of the invention, there is provided an apparatus mountable to a wall of water management device for storing liquid, the apparatus comprising a container suitable for holding liquid; a duct, coupled to the container and configured to allow passage of liquid from the container to enable liquid to be received therefrom.

As with the first aspect mentioned above, in a preferred embodiment of the third aspect, the water management device is a water butt. However, other water management devices such as liquid containers other than water butts, or liquid transport pipes such as rainwater drainpipes, rainwater downpipes, waste pipes, sewerage pipes and so on are also envisaged. For the remainder of the description, the preferred embodiment of a water butt will be referred to. However, it will be appreciated that an apparatus according to the third aspect of the invention is not limited to use only with water butts.

When the water management device is a water butt, it is preferred that the apparatus is mountable to a side of the water butt for storing liquid separately from the primary liquid store of the water butt.

As explained above, by providing a separate store of liquid from the primary liquid store of the water butt, it is possible to ensure a more reliable supply of liquid in certain circumstances. Thus, as the primary liquid store becomes depleted, the auxiliary liquid store maintains a supply of liquid for use at a given location, such as a higher location than the primary liquid store, for example to provide a longer lasting supply of water for one or more preferred plants, or to provide a supply of water for plants at a higher location than those watered by the primary liquid store. The separate store may also be used for delivering different kinds of liquid from the primary store, such as liquid feed or water with particular nutrients dissolved therein.

The same or equivalent features mentioned above in respect of the first aspect may be provided on the second aspect to similar or equivalent effect.

In a fourth aspect of the invention, there is provided a water butt comprising a first liquid reservoir; and a second liquid reservoir separate from the first. Further liquid reservoirs (i.e. three, four or more) may also be provided, if desired. The reservoirs may be integral to or removably separable from the water butt.

The second liquid reservoir may have a variety of purposes. For instance, the second liquid reservoir may be used for storing a different kind of liquid from the first liquid reservoir, such as a liquid feed or water with particular nutrients dissolved therein. Alternatively, the second liquid reservoir may provide an emergency store of liquid in case the first liquid reservoir is depleted.

The second reservoir may be position differently from the first. In one optional arrangement, the second reservoir is higher than the first reservoir. In use. As explained above, this enables water to be supplied to plants at a particular height above the water butt for longer than could be achieved using the first reservoir alone.

Optionally, the water butt comprises a water pump for pumping liquid from the first reservoir to the second reservoir. This enables the second liquid reservoir to be refilled from the first liquid reservoir if it becomes depleted. The pump may be powered by renewable energy such as wind or solar power.

In some embodiments, the water butt may comprise means for collecting rainwater, such as guttering or drain pipes. The means for collecting rainwater may be adapted to direct the collected rainwater into each of the first and second liquid reservoirs. Water could be directed to the first and second liquid reservoirs evenly, or in a particular proportion.

Optional aspects of the invention are specified in the appended dependent claims.

For the purposes of this description, the term “water management device” refers to any device for holding or transporting water, and “water butt” refers to a device comprising an interior volume for storing liquid. The liquid is typically predominately water, although additives such as plant fertilisers or cleaners may be included. The water stored in a water butt may come from any suitable source, for example rain or tap water. A water butt may be made from any suitable material, such as plastic, metal or wood. A water butt typically incorporates a tap for draining stored liquid from the water butt. A water butt may be any suitable shape or size. For instance, a water butt may be a domestic water butt, the likes of which typically have a capacity of between 50 and 500 litres, for example (although other capacities are possible). Alternatively, a water butt may be an industrial or commercial water butt having a much greater capacity of many hundreds or thousands of litres. Irrespective of the size of the water butt, the principles of the invention are the same. Finally, a water butt typically comprises a base and at least one side, which defines the interior volume.

For the purposes of this description, the term “plants” refers to living organisms of the kingdom Plantae. The term plants is not limited to land plants which require soil or hydroponics to grow, but also encompasses aquatic plants, such as water lilies.

### BRIEF DESCRIPTION OF THE DRAWINGS

The invention is described in more detail below with reference to the accompanying drawings, in which:

FIG. 1 is a section view of first embodiments of apparatuses according to the first and third aspects of the invention, mounted to a water butt;

FIG. 2 is a section view of four sets of apparatuses shown in FIG. 1, mounted to a water butt;

FIG. 3 is a section view of a second embodiment of an apparatus according to the first aspect of the invention, mounted to a water butt;

FIG. 4 is a perspective view of a third embodiment of an apparatus according to the first aspect of the invention;

FIG. 5 is a perspective view of the a fourth embodiment of an apparatus according to the first aspect of the invention connected to a second embodiment of an apparatus according to the third aspect of the invention:

FIG. 6 is a side view of a first embodiment of a water butt according to the second aspect of the invention;

FIG. 7 is a section view of a second embodiment of a water butt according to the second aspect of the invention;

FIG. 8 is a section view of a third embodiment of a water butt according to the second aspect of the invention;

FIG. 9 is a side view of a fourth embodiment of a water butt according to the second aspect of the invention;

FIG. 10 is a section view of a first embodiment of a water butt according to the fourth aspect of the invention;

FIG. 11 is a plan section view of the water butt shown in FIG. 10, on which is mounted an apparatus according to the first aspect of the invention;

FIG. 12 is a plan view of a sixth embodiment of a container according to the first aspect of the invention;

FIG. 13 is a section view of the sixth embodiment of a container according to the first aspect of the invention; and

FIG. 14 is a section view of a seventh embodiment of a container according to the first aspect of the invention.

### DETAILED DESCRIPTION

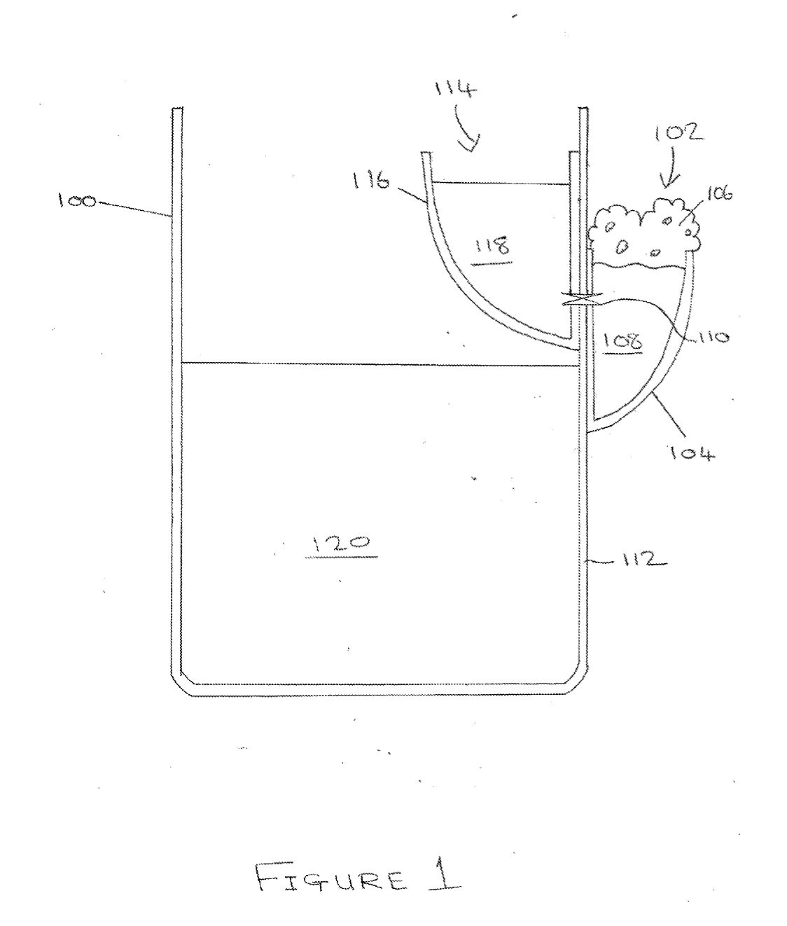

First embodiments of the first and third aspects of the invention are shown in FIG. 1, connected to a water butt 100.

As can be seen from the figure, a first apparatus 102 comprises a container 104. The container 104 is suitable for holding one or more plants and, as shown, holds plant 106 rooted in soil 108. Of course, the container 104 need not hold plants 106 and soil 108 in the manner shown and may instead be adapted to hold one or more plants in any suitable manner, with or without means for sustaining them. For example, the container may simply be a platform on which one or more plants contained in pots may be placed. Alternatively, the container may be a hydroponic container.

A duct 110 is coupled to the container 104, and allows for passage of liquid from the interior of the water butt 100 to the container 104. The particular form of the duct 110 is not shown in FIG. 1. At the very least, the duct 110 is an aperture which permits liquid to pass from outside the container 104 to within the container 104. In one embodiment, the duct comprises a tube. The duct 110 may further comprise or consist of a metering device (not shown) which is adapted to limit the rate at which liquid passes into the container 104. Suitable metering devices include a valve, which may be actuated mechanically or electrically; a semi-permeable membrane; a constriction or a component having aperture, the diameter of which is small enough to limit rate at which liquid passes into the container 104 to a desired rate. Alternatively, the duct 110 itself may be dimensioned such that the desired rate of liquid passage may be achieved without the use of additional flow-limiting means. Irrespective of which means is provided, the desired rate of liquid passage will depend on the particular application. For large commercial or industrial arrangements, the flow rate may be between 0 and 15 litres per hour, for example; preferably between 2 and 13 litres per hour; more preferably between 5 and 10 litres per hour, more preferably between 6 and 8 litres per hour. For domestic arrangements, the flow rate may be between 50 millilitres and 5 litres per day, for example; preferably between 100 millilitres and 3 litres per day; more preferably between 500 millilitres and 2 litres per day; more preferably between 1 litre and 1.5 litres per day. Other flow rates are also possible, and irrespective of the flow rate, the principles of the Invention are the same.

The container 104 is mountable to the water butt 100 and in FIG. 1 is shown mounted to a first side 112 of the water butt 100. The container 104 may be mountable to the water butt by any suitable means, such as one or more bolts, one or more hooks, adhesive, or by means of the duct 110. Typically, a water butt has a circular cross-section in plan, and thus only a single side. The container 104 may be mountable anywhere on that side. Water butts may be provided with other shapes having more sides, and the container may be mountable on any such sides. It Is preferred that the container be mountable to on the outside of the water butt 100, but this need not be the case. Alternatively, as described below with reference to the third aspect of the invention, the container may be integral to the water butt.

The container 104 may be made from any suitable material for holding plants, including plastic, metal or wood. The container may be manufactured according to any suitable process, such as casting, moulding (for example injection moulding or rotational moulding), pressing, forging, welding, and so on.

As shown in FIG. 1, a second apparatus 114 comprises a container 116 which provides an auxiliary liquid reservoir to the primary liquid store 120 of the water butt 100. The container 116 is suitable for holding liquid and, as shown, contains water 118.

A duct 110 is coupled to the container 116, and allows for passage of liquid from the container 116 to the outside of the water butt 100. The particular form of the duct 110 is not shown in FIG. 1. At the very least, the duct 110 is an aperture which permits liquid to pass from inside the container 116 to outside the container 116. In one embodiment, the duct comprises a tube. The duct 110 may further comprise or consist of a metering device (not shown) which is adapted to limit the rate at which liquid passes out of the container 116. Suitable metering devices include a valve, which may be actuated mechanically or electrically; a semi-permeable membrane; a constriction or a component having aperture, the diameter of which is small enough to limit rate at which liquid passes out of the container 116 to a desired rate. Alternatively, the duct 110 itself may be dimensioned such that the desired rate of liquid passage may be achieved without the use of additional flow-limiting means. As explained above, irrespective of which means is provided, the desired rate of liquid passage will depend on the particular application, and may be between 0 and 15 litres per hour, for example; preferably between 2 and 13 litres per hour; more preferably between 5 and 10 litres per hour, more preferably between 6 and 8 litres per hour. Alternatively, the flow rate may be between 50 millilitres and 5 litres per day, for example; preferably between 100 millilitres and 3 litres per day; more preferably between 500 millilitres and 2 litres per day; more preferably between 1 litre and 1.5 litres per day. Other flow rates are also possible.

In the embodiments shown in FIG. 1, the apparatuses 102 and 114 share a common duct 110. The common duct 110 permits liquid to pass from inside the container 116 to inside the container 104. In other embodiments, the apparatuses 102 and 114 may be mounted to the water butt 100 separately, with separate respective ducts.

The container 116 is mountable to the water butt 100 and in FIG. 1 is shown mounted to a first side 112 of the water butt 100. The container 116 may be mountable to the water butt by any suitable means, such as one or more bolts, one or more hooks, adhesive, or by means of the duct 110. Typically, a water butt has a circular cross-section in plan, and thus only a single side. The container 104 may be mountable anywhere on that side. Water butts may be provided with other shapes having more sides, and the container may be mountable on any such sides. It is preferred that the container 116 be mountable to on the inside of the water butt 100, but this need not be the case. Alternatively, as described below with reference to the fourth aspect of the invention, the container may be integral to the water butt.

The container 116 may be made from any suitable material for holding liquid, including plastic, metal or wood. The container may be manufactured according to any suitable process, such as casting, moulding (for example injection moulding or rotational moulding), pressing, forging, welding, and so on.

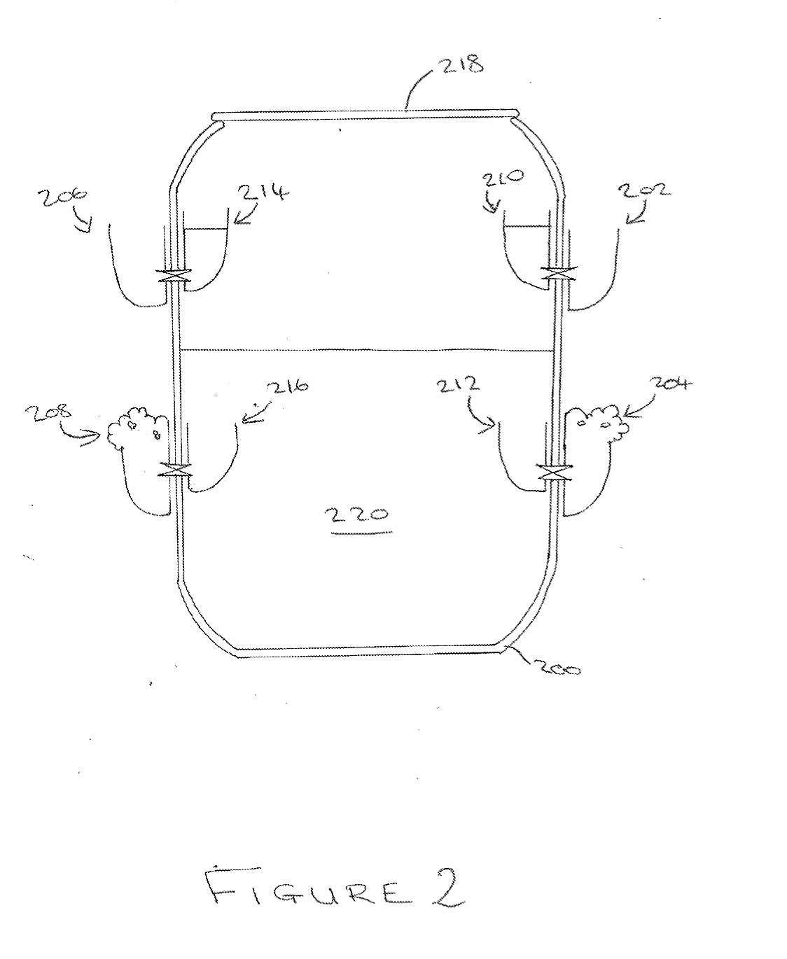

FIG. 2 shows a water butt 200 with a lid 218 comprising a plurality of the apparatuses shown in FIG. 1 mounted at different locations on the water butt. Apparatuses 202, 204, 206 and 208 are identical to apparatus 102 of FIG. 1, and auxiliary liquid reservoirs 210, 212, 214 and 216 are identical to apparatus 114 of FIG. 1. Apparatuses 204 and 208 are shown holding plants, whereas apparatuses 202 and 206 are empty. Auxiliary liquid reservoirs 212 and 216 are below the water line of the primary liquid store 220 of the water butt 200, whereas auxiliary liquid reservoirs 210 and 214 are above. As will be apparent from the illustrated embodiment, the auxiliary liquid reservoirs 210, 212, 214 and 216 will be refilled from the primary liquid store 220 of the water butt 200 when the water line of the primary liquid store 220 rises above the top of each auxiliary liquid reservoir 210, 212, 214 and 216. As will be explained further below, each auxiliary liquid reservoir could be filled independently of the primary liquid store 220.

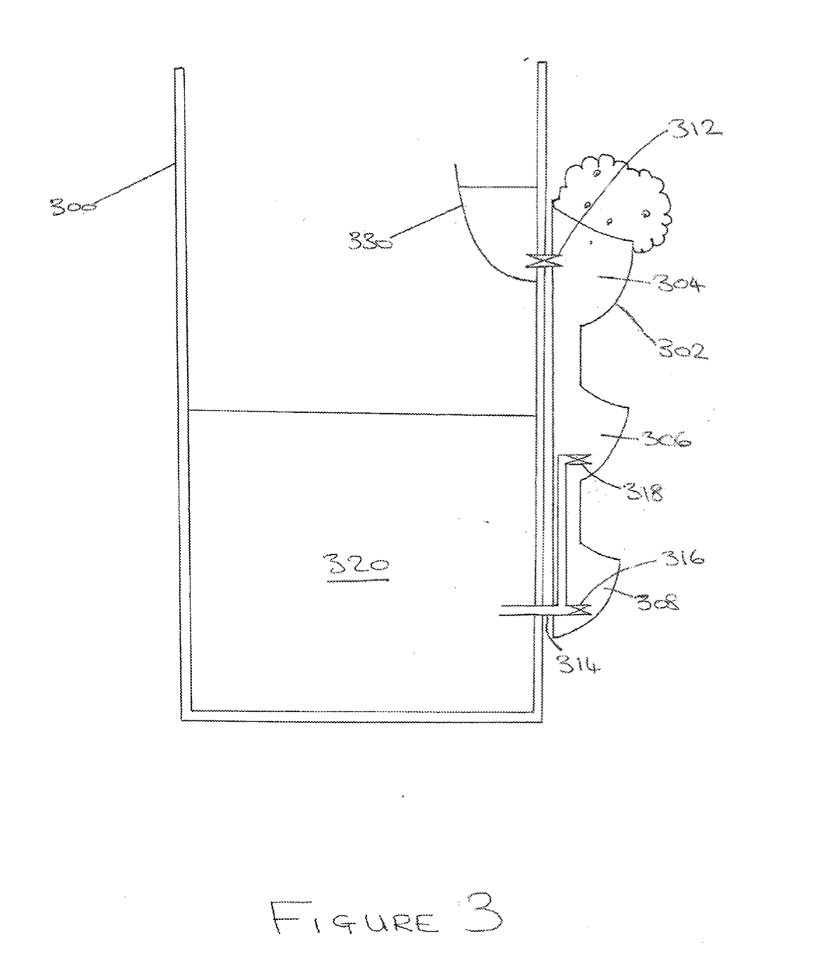

FIG. 3 shows an apparatus 302 according to a second embodiment of the first aspect of the invention. The apparatus 302 comprises a plurality of containers 304, 306, 308 suitable for holding one or more plants. Container 302 is shown holding plants whereas containers 306 and 308 are empty. Containers 304, 306 and 308 form one single apparatus 302. As shown in FIG. 3, the containers 304, 306 and 308 are integrally formed. However, in alternative embodiments, the plurality of containers may be connected by any suitable means, such as bolts, hooks, or a connecting frame.

Containers 304, 306, 308 are shown vertically aligned. However, in alternative embodiments, apparatus may comprise a plurality of containers in different configurations, such as horizontally aligned, diagonally aligned, or unaligned.

In some embodiments, drainage holes, ducts or channels may allow excess liquid to drain from higher containers to lower containers, for example from container 304 to container 306, or from container 306 to container 308. This cascading effect is an efficient use of liquid as excess liquid from one container may be used in another.

The apparatus 302 comprises a first duct 312 which is identical to the duct 110 of the first embodiment of the first aspect of the invention shown in FIG. 1.

The apparatus 302 further comprises a second duct 314 which is coupled to containers 306 and 308. As shown, the second duct is coupled to two containers 306 and 308 by virtue of a first channel passing from inside the water butt to a first container 308, and a second channel connected to the first channel and to a second container 306. However, the duct may be provided any number of containers, and using any convenient arrangement of channels.

The duct 314 may comprise one or more metering devices as described above with reference to the first embodiment of the first aspect of the invention. As shown, a metering device is provided in each channel for each container 306 and 308. This is advantageous because the flow to each container may be managed independently whilst using a single duct. However, a single metering device could be provided in the duct so as to restrict the flow into all channels and/or to all containers together.

The apparatus 302 may be mounted to the water butt 300 by any suitable means, as described above for the apparatus 102 shown in FIG. 1. Similarly, as described below with reference to the second aspect of the invention, the apparatus 302 may be integral with the water butt 300.

Apparatus 330 is identical to apparatus 114 of FIG. 1. However, this arrangement is merely optional. As described below, other embodiments of an auxiliary reservoir could be connected to the apparatus 302.

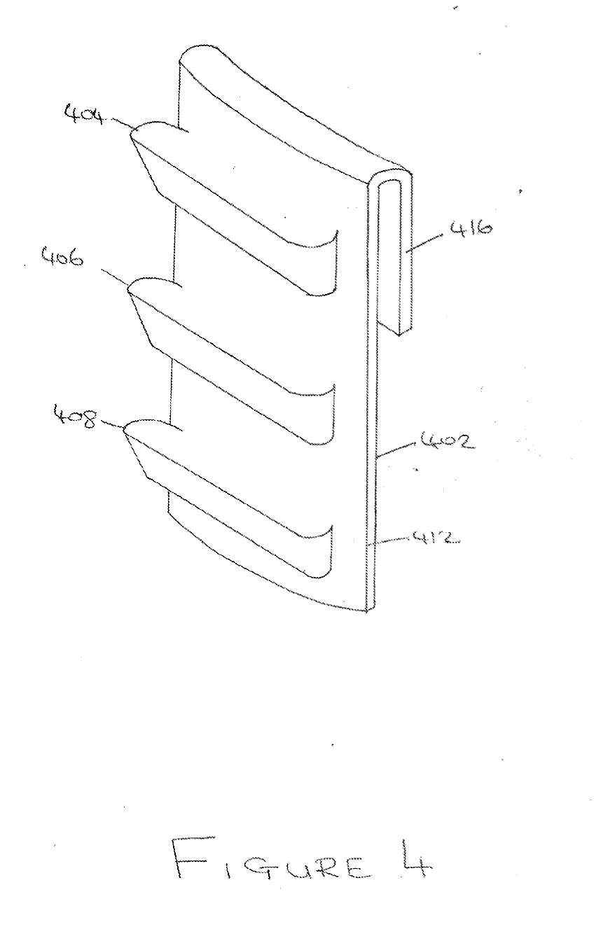

A third embodiment of an apparatus in accordance with the first aspect of the invention is shown in FIG. 4. The apparatus 402 comprises three containers 404, 406 and 408 suitable for holding one or more plants. The containers 404, 406 and 408 are integrally formed with a backing plate 412. The backing plate 412 comprises an integral hooked portion 416 adapted to hook over the lip of a water butt. Of course, any number of containers could be used in this embodiment, and the containers may be removably attachable to the backing plate 412. The backing plate may be made of any suitable material including plastic, metal or wood.

As described above, ducts (not shown) couple to each of the containers 404, 406 and 408 to allow for passage of liquid from a water butt to the containers 404, 406 and 408.

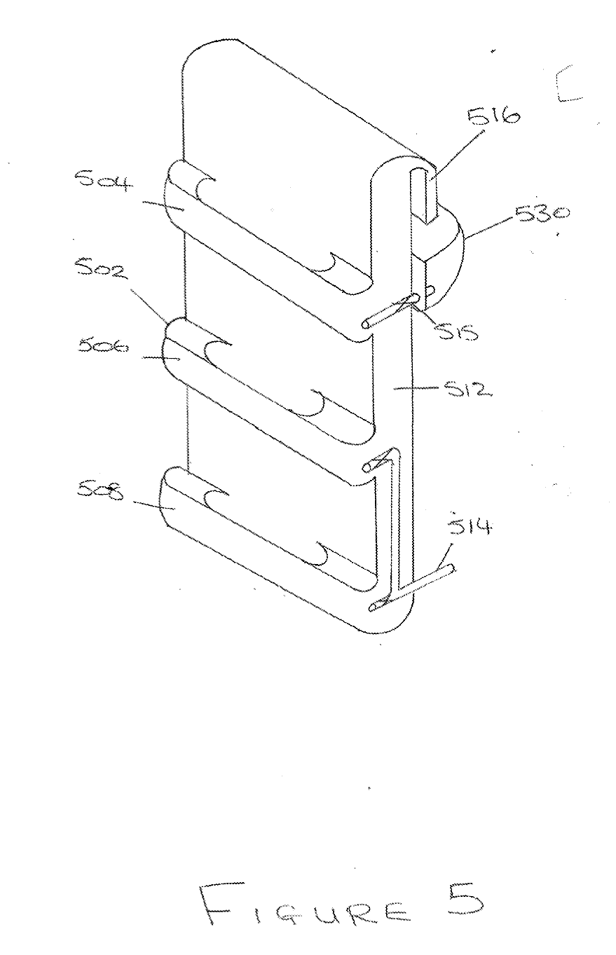

Apparatus 502 according to a further embodiment of the first aspect of the invention is shown in FIG. 5. Apparatus 502 is similar to apparatus 402 shown in FIG. 4, with the addition of ducts 512 and 514, and auxiliary liquid reservoir 530. Duct 514 couples to containers 506 and 508, and is identical to duct 314 in FIG. 3.

Duct 515 couples container 504 to auxiliary liquid reservoir 530.

Auxiliary liquid reservoir 530 is connected to the folded section 516 of the backing plate 512 of the apparatus 502. In use, the hooked portion 516 is hooked over the top of the side of a water butt, and duct 515 passes through the side of the water butt, coupling the container 504 external to the water butt to the auxiliary liquid reservoir 530 internal to the water butt.

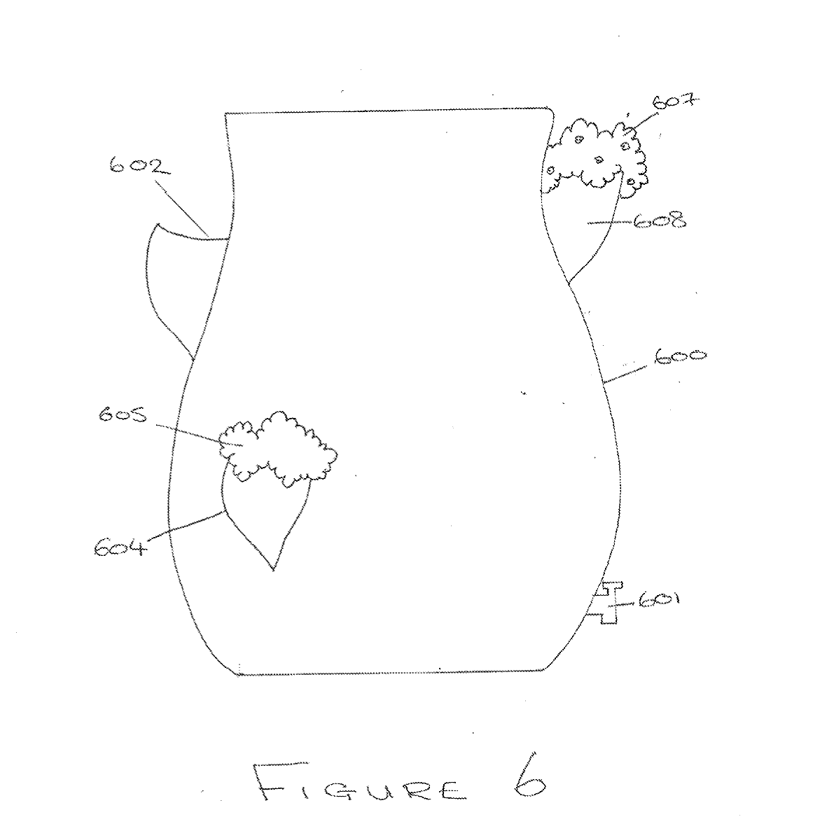

FIG. 6 shows a water butt 600 in accordance with a second aspect of the invention. The water butt comprises a tap 601 for drawing liquid from the water butt liquid store.

The water butt 600 further comprises three integral containers 602, 604, 608 suitable for holding one or more plants. Containers 604 and 608 are shown holding plants 605 and 607, whereas container 602 is empty. The integral containers may be formed using the same casting, moulding (for example injection moulding or rotational moulding), pressing, forging or welding process as the water but itself.

Whilst integral containers 602, 604 and 608 are shown, it is possible to provide a water butt having removably attachable containers, for example as part of a kit. Integral or removably attachable containers for providing one or more auxiliary liquid reservoirs may also be provided with the water butt of this embodiment.

Ducts (not shown) couple to the containers 602, 604 and 608 to allow passage of liquid from the water butt 600 to the containers 602, 604 and 608, in the same way as described for the embodiments of FIG. 1, for example.

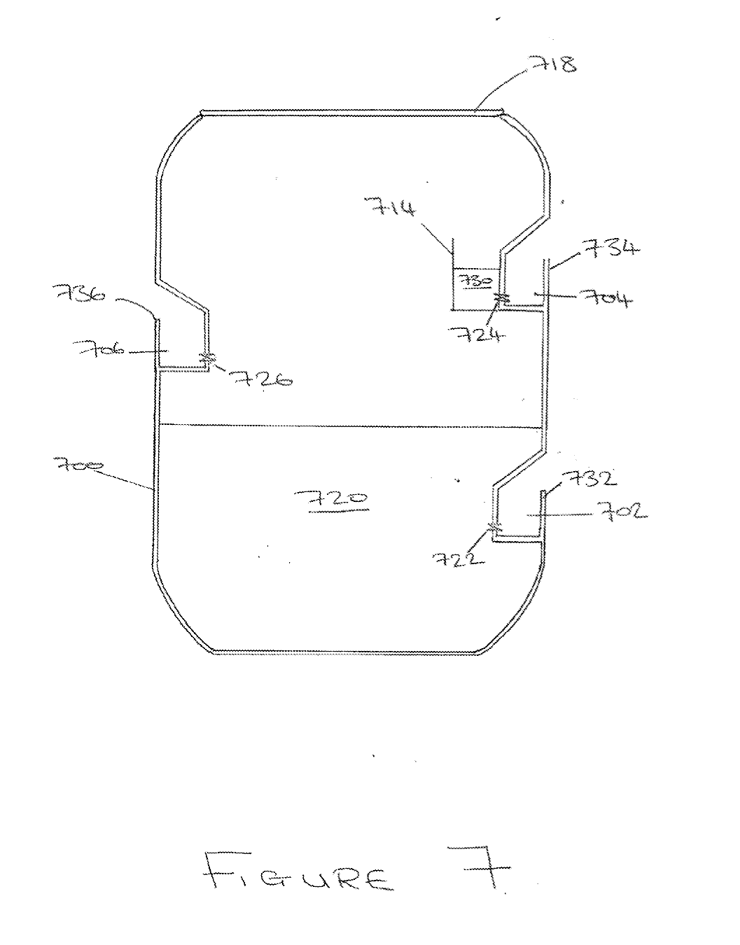

A second embodiment of the second aspect of the invention is shown in FIG. 7. Here, a water butt 700 comprises an optional lid 718 and three integral containers 702, 704, 706. As shown in the figure, the integral containers are recessed within the body of the water butt and are thereby formed by the same wall which forms the interior volume of the water butt. Optional side walls 732, 734, 736 are provided for the respective containers 702, 704, 706. Whilst three containers are shown, any number of containers may be provided.

The containers 702, 704, 706 are each suitable for holding one or more plants, although they are shown empty. The containers 702, 704, 706 may be adapted to hold one or more plants in any suitable manner, with or without means for sustaining them. For example, the containers may be hold plants and soil. Alternatively, the containers may simply be a platform on which one or more plants contained in pots may be placed. Alternatively, the containers may be hydroponic containers.

Ducts 722, 724, 726 are coupled to each respective container 702, 704, 706 and allow for passage of liquid from the water butt 700 to the containers 702, 704, 706. The particular form of the ducts 722, 724, 726 is not shown in FIG. 7. At the very least, the duct 722, 724, 726 is an aperture which permits liquid to pass from the interior volume of the water butt 700 to within the respective container 702, 704, 706. In one embodiment, the duct 722, 724, 726 comprises a tube. The duct 722, 724, 726 may further comprise or consist of a metering device (not shown) which is adapted to limit the rate at which liquid passes into the respective container 702, 704, 706. Suitable metering devices include a valve, which may be actuated mechanically or electrically; a semi-permeable membrane; a constriction or a component having aperture, the diameter of which is small enough to limit rate at which liquid passes into the container 104 to a desired rate. Alternatively, the ducts 722, 724, 726 themselves may be dimensioned such that the desired rate of liquid passage may be achieved without the use of additional flow-limiting means. As explained above, irrespective of which means is provided, the desired rate of liquid passage will depend on the particular application, and may be between 0 and 15 litres per hour, for example; preferably between 2 and 13 litres per hour; more preferably between 5 and 10 litres per hour; more preferably between 6 and 8 litres per hour. Alternatively, the flow rate may be between 50 millilitres and 5 litres per day, for example; preferably between 100 millilitres and 3 litres per day; more preferably between 500 millilitres and 2 litres per day; more preferably between 1 litre and 1.5 litres per day. Other flow rates are also possible.

A container 714 for providing an auxiliary liquid reservoir to the primary liquid store 720 of the water butt 700 is also shown in FIG. 7. The container 714 is suitable for holding liquid and, as shown, contains water 730. Of course, such a container could be provided for any or all of containers 702, 704, 706.

The container 714 is shown as integrally formed with the water butt 700. Alternatively, the container 714 may be mountable or removably connectable to the water butt 700 by any suitable means, such as one or more bolts, one or more hooks, adhesive, or by means of the duct 724. Typically, a water butt has a circular cross-section in plan, and thus only a single side. The container 714 may be disposed anywhere on that side. Water butts may be provided with other shapes having more sides, and the container 714 may be disposed on any such sides. It is preferred that the container 714 be disposed on the inside of the water butt 700, but this need not be the case.

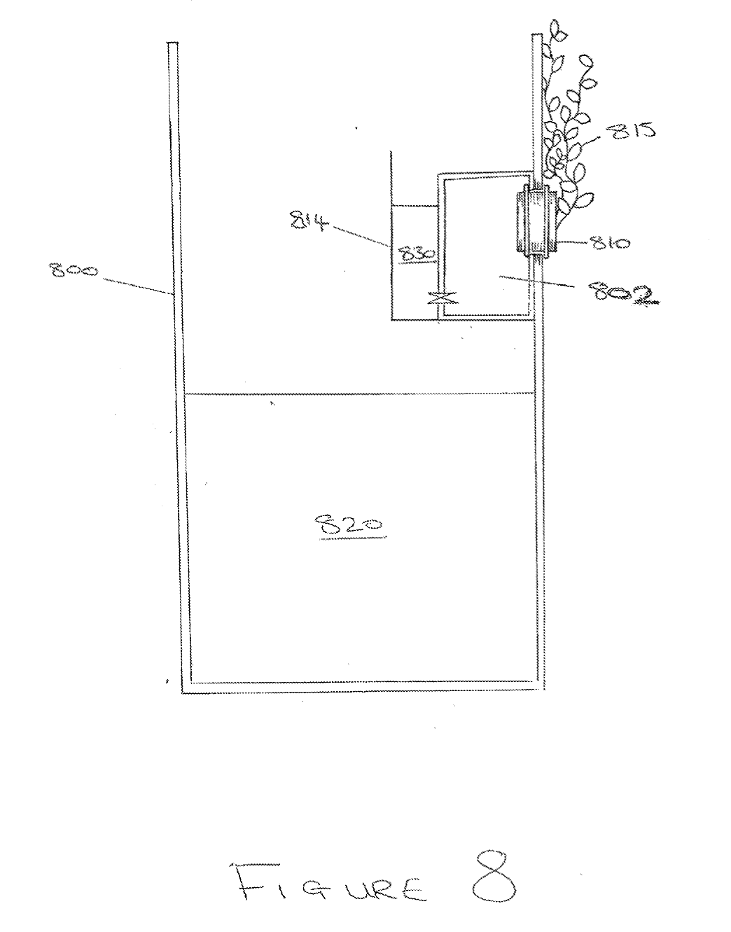

An alternative embodiment of the second aspect of the invention is shown in FIG. 8. Container 802 is similar to the containers 702, 704, 706 shown in FIG. 7 and described above. The container 802 comprises a decorative portal 810 from the inside of the container 802 to the outside, through which a plant 815 is shown growing. The portal 810 may be purely decorative, or, if the container is removably connectable to the water butt 800, may comprise mounting means for connecting the container 802 to the water butt 800.

Container 814 is identical to container 714 shown in FIG. 7. The container 814, as shown, contains water 730, and provides an auxiliary liquid reservoir to the primary liquid store 820 of the water butt 800.

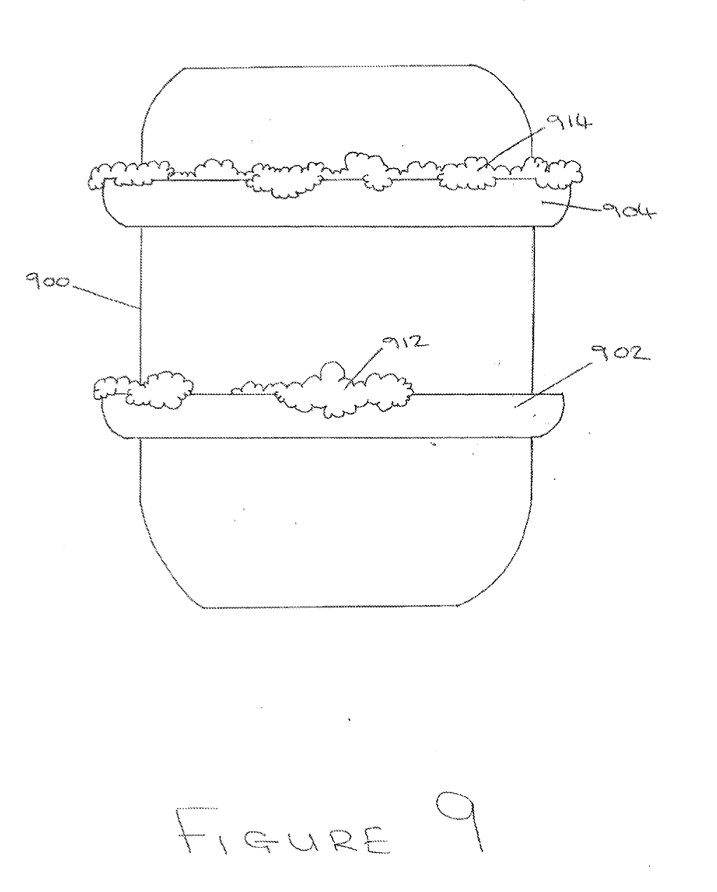

The water butt 900 shown in FIG. 9 comprises two containers 902, 904 suitable for holding one or more plants. The containers are shown holding plants 912 and 914. In this embodiment ducts (not shown), identical to duct 110 described in relation to FIG. 1, couple to the containers 902, 904 to allow passage of liquid from the water butt 900 to the containers 902, 904. Each container 902, 904 comprises at least one respective duct, although in some embodiments more than one duct may couple to each container 902, 904. As shown, the containers 902, 904 surround or encircle the water butt 900. However, they could be of any size or shape, as described previously.

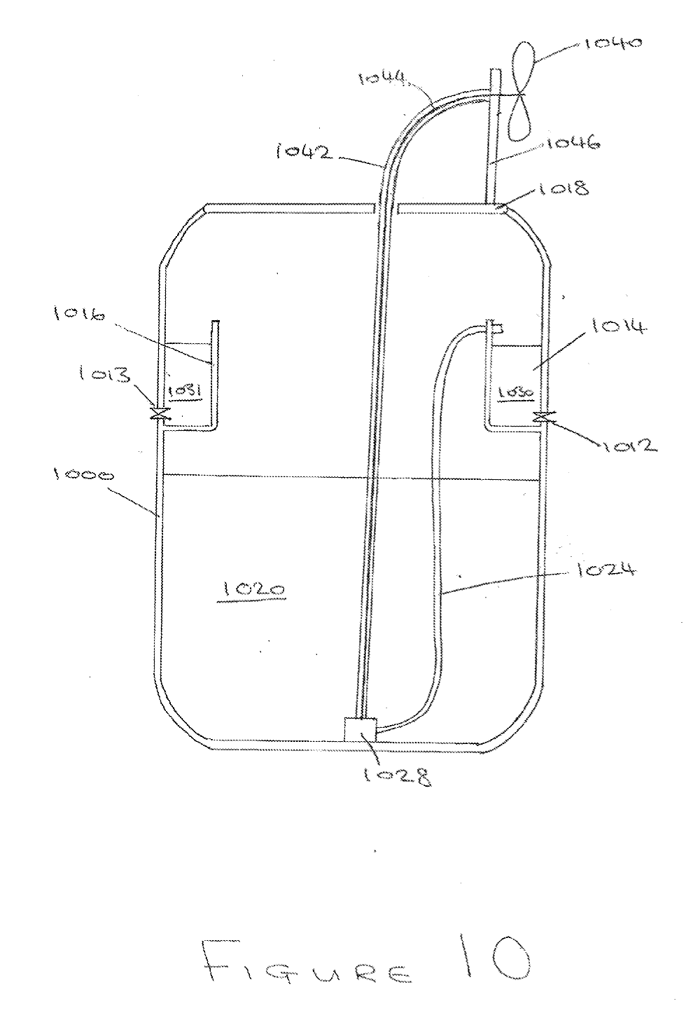

An embodiment of the fourth aspect of the invention is shown in FIG. 10. A water butt 1000 with a lid 1018 is shown with a first liquid reservoir 1020. Further liquid reservoirs 1030, 1031 are provided separate from the first liquid reservoir 1020. Containers 1014 and 1016 are suitable for holding liquid and, as shown, contain water 1030, 1031. The containers provide liquid reservoirs separate to the primary liquid store 1020 of the water butt 1000. It will be appreciated that containers for holding plants according to the first aspect of the invention could be coupled to the containers 1014, 1016 if desired. Alternatively, one or more taps could be provided to gain access to the water stored in the containers 1014, 1016.

Ducts 1012, 1013 are provided as drainage points for drawing liquid from the containers 1030, 1031. Ducts 1012, 1013 are coupled to each respective container 1030, 1031 and allows for passage of liquid from the containers 1030, 1031. The particular form of the ducts 1012, 1013 is not shown in FIG. 10. At the very least, the duct 1012, 1013 is an aperture which permits liquid to pass out from the respective container 1030, 1031. The duct may comprise or consist of a tap, or be attachable to a tap.

The duct may feed water directly into a container for holding plants. In one embodiment, the duct 1012, 1013 comprises a tube. The duct 1012, 1013 may further comprise or consist of a metering device (not shown) which is adapted to limit the rate at which liquid passes into the respective container 1030, 1031. Suitable metering devices include a valve, which may be actuated mechanically or electrically; a semi-permeable membrane; a constriction or a component having aperture, the diameter of which is small enough to limit rate at which liquid passes into the container 104 to a desired rate. Alternatively, the ducts 1012, 1013 themselves may be dimensioned such that the desired rate of liquid passage may be achieved without the use of additional flow-limiting means. As explained above, irrespective of which means is provided, the desired rate of liquid passage will depend on the particular application, and may be between 0 and 15 litres per hour, for example; preferably between 2 and 13 litres per hour, more preferably between 5 and 10 litres per hour; more preferably between 6 and 8 litres per hour. Alternatively, the flow rate may be between 50 millilitres and 5 litres per day, for example; preferably between 100 millilitres and 3 litres per day; more preferably between 500 millilitres and 2 litres per day; more preferably between 1 litre and 1.5 litres per day. Other flow rates are also possible.

The containers 1014, 1016 are shown as integrally formed with the water butt 1000. Alternatively, the containers 1014, 1016 may be mountable or removably connectable to the water butt 1000 by any suitable means, such as one or more bolts, one or more hooks, adhesive, or by means of the respective ducts 1012, 1013.

A container 1014, 1016 may be disposed anywhere in relation to the water butt. The containers 1014, 1016 shown in FIG. 10 are disposed on the interior side of the water butt 1000, higher than the primary liquid store (or first liquid reservoir) 1020 when the water butt 1000 is in use. Providing a second liquid reservoir higher than the first liquid reservoir in use facilitates the use of that water at a greater height without the use of a pump. For example, the water stored in container 1014 of FIG. 10 may water plants at a higher level than could be watered by the first liquid store 1020. In alternative embodiments, the containers 1014, 1016 may be disposed at the same height as the first liquid reservoir 1020 in use. In further embodiments the containers 1014, 1016 may be disposed lower than the first liquid reservoir 1020 in use. It Is preferred that the containers 1014, 1016 are disposed on the inside of the water butt 1000, but this need not be the case.

The first liquid reservoir 1020 and second liquid reservoirs 1030 and 1031 are shown in FIG. 10 holding water. However, the reservoirs 1020, 1030 and 1031 may contain any suitable liquid, such as water with additives such as plant fertilisers or cleaners. The liquid in each separate reservoir 1020, 1030, 1031 may be the same, or the liquid stored in each reservoir 1020, 1030, 1031 may be of different composition. For example, the first liquid reservoir 1020 may store water, while the second liquid reservoir 1030 stores water with additives.

Also shown in FIG. 10 is a pump 1028 adapted to pump liquid from the first liquid reservoir 1020 to the container 1014 via a pipe or hose 1024. The pump 1028 may be powered by any suitable means, for example mains power or battery power. Preferably, the pump is powered by renewable energy, such as wind power or solar power. In FIG. 10, the pump is shown as wind powered, with a wind turbine 1040, mounted on a stand 1046 attached to the lid 1018 of the water butt 1000. A waterproof hose 1042 surrounds a wire 1044 which connects the wind turbine 1040 to the pump 1028.

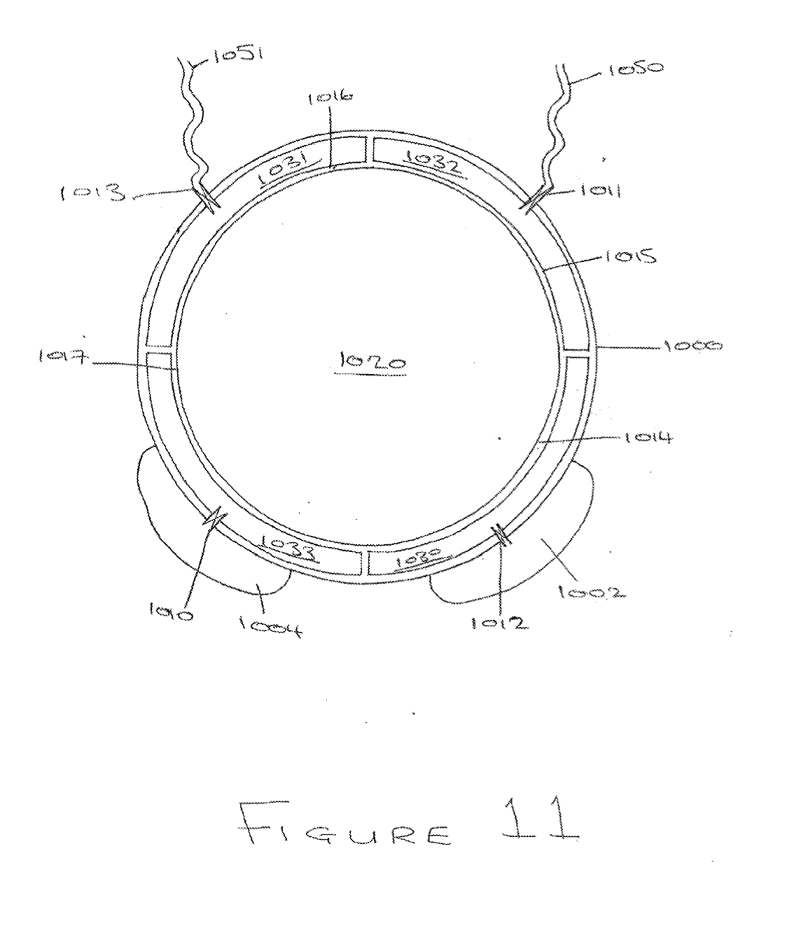

The water butt 1000 of FIG. 10 is also shown in FIG. 11. In this figure two further containers 1015, 1017 are shown which provide two further liquid reservoirs 1032, 1033 separate to the first liquid reservoir 1020 of the water butt 1000. The containers 1015, 1017 are identical to the containers 1013 and 1014 described above. The two containers 1015 and 1017 comprise respective ducts 1011, 1010 provided as drainage points for drawing liquid from the respective containers 1015, 1017. The ducts 1010, 1011, are identical to the ducts 1012, 1013 described above.

In the embodiment shown in FIG. 11, ducts 1010 and 1012 feed water directly into containers 1002, 1004, which are suitable for holding one or more plants. The containers 1002, 1004 shown in FIG. 11 are identical to the container 104 according to the first aspect of the present invention and described above in relation in FIG. 1. In alternative embodiments, the containers 1002, 1004 may be integral with the water butt 1000.

In this embodiment ducts 1011 and 1013 are connected to hose pipes 1050 and 1051 respectively, through which the liquid stored in containers 1015 and 1016 may flow.

In each of the aforementioned embodiments, the apparatus may be provided with means for collecting rainwater and distributing it appropriately between the primary liquid store (or first reservoir) and auxiliary liquid stores (or second reservoir). This may be achieved by any convenient means, such as using pipework coupled between the rainwater entry point (for example, a drainpipe) and each of the reservoirs or liquid stores. The pipework may be adapted to distribute the rainwater evenly between the plurality of reservoirs or liquid stores, or in some proportion corresponding to the volume of the reservoirs or liquid stores. However, such pipework is optional. The reservoirs or liquid stores may simply be filled when the primary liquid store fills to a point at which the rainwater flows over into the reservoirs or liquid stores, as shown in FIG. 2, for example.

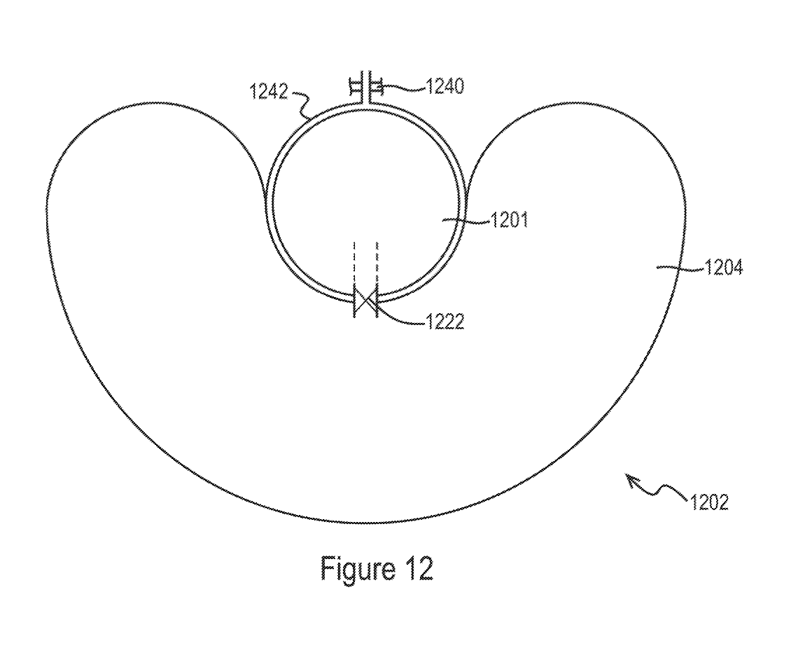

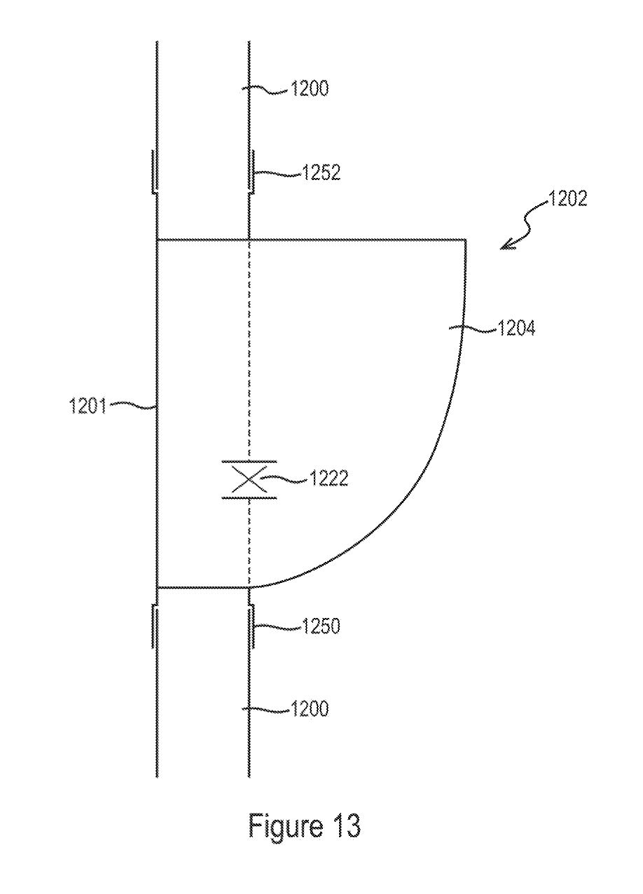

A sixth embodiment of the first aspect of the invention is shown in FIGS. 12 and 13. Except for the following differences, the sixth embodiment of the first aspect of the invention is identical to the previously described embodiments.

As can be seen from the figures, an apparatus 1202 comprises a container 1204 suitable for holding one or more plants. The container is shaped to partially surround a section 1201 of a downpipe 1200, such as a rainwater downpipe. The apparatus further comprises a duct 1222 coupled to the container 1204 configured to allow passage of liquid from the interior of the downpipe 1200 to the container 1204. The duct may be identical to ducts described above with reference to previous embodiments. The duct 1222 may further comprise or consist of a metering device (not shown) which is adapted to control the rate at which liquid passes into the container 1204, as described above with reference to previous embodiments. The metering device may comprise wicking material which facilitates the transport of liquid from the rainwater downpipe 1200 to the container 1204.

The apparatus may further comprise means for directing water flowing down the downpipe towards the duct 1222. Such means may comprise, for example, an inclined collar around the interior surface of the downpipe section 1201; a textured surface or flow channels etched on the interior surface of the downpipe section 1201; or a collar of wicking material around the inner surface of the downpipe to absorb the liquid. Alternatively or additionally, the apparatus may comprise water storage means for storing liquid before it passes through the duct 1222 to the container 1204 in a similar manner to the auxiliary liquid reservoirs described previously. Such a water storage means may comprise, for example, a water reservoir of any suitable horizontal cross sectional shape (such as semi-circular, or annular). Water storage means may further comprise a trapdoor which is configured to open if the weight of stored water exceeds some predetermined threshold, preventing blockage of the downpipe.

The container 1204 may be mountable to the side of a section of downpipe 1201 using any suitable means, such as those described above with reference to previous embodiments. Alternatively, the container 1204 may be mounted to the downpipe section 1201 using a collar 1242 and fastening 1240 as shown in FIG. 12.

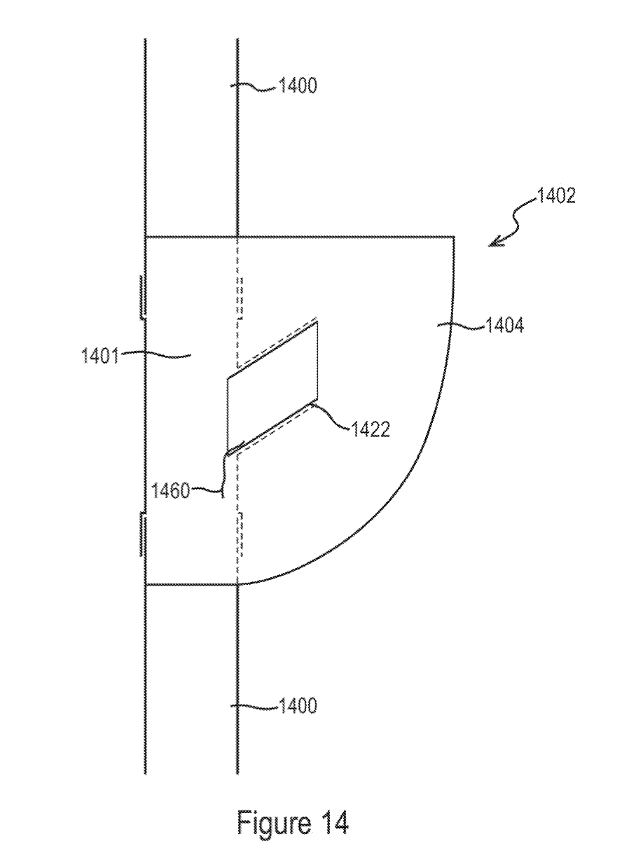

In some embodiments, the container 1204 may be integrally formed with a section of downpipe 1201, and the integrally formed downpipe 1201 and container 1202 may be mounted between sections of a downpipe 1200 using any suitable means, such as overlapping joiners 1250, 1252. Conventionally, downpipes are formed of a series of standard modular sections which are connected using suitable means such as overlapping joiners. Therefore, where the container 1204 is integrally formed with a section of downpipe 1201, the integrally formed section of downpipe 1201 may be installed in a downpipe when the downpipe is first assembled, or may replace a standard section of downpipe in a previously assembled downpipe. FIG. 14 shows a seventh embodiment of the first aspect of the invention similar to the sixth embodiment described above. The apparatus 1402 comprises a container 1404 suitable for holding plants mounted to a section 1401 of a downpipe 1400.

The duct 1422 shown in FIG. 14 which allows passage of liquid from the downpipe 1400 to the container 1404 is formed of a conventional T section of downpipe. The duct 1422 may form any suitable angle with the vertical downpipe, such as a right angle, 45 degrees, 135 degrees, or any suitable angle. A portion of wicking material 1460 is shown extending from the duct 1422 into downpipe 1400. In some embodiments, wicking material 1460 may extend through the duct 1422 into container 1404 to wick liquid from the downpipe 1400 to the container 1404.

It will be appreciated that modifications to the embodiments described herein may be made without departing from the invention, which is defined by the appended claims.

1. An apparatus mountable to a water management device for receiving liquid therefrom, the apparatus comprising:
a container suitable for holding one or more plants; and
a duct coupled to the container, and configured to allow passage of liquid from the water management device to the container.

2. The apparatus of claim 1, wherein the container comprises a plurality of containers, each suitable for holding one or more plants.

3. The apparatus of claim 1 or claim 2, further comprising a plurality of ducts fluidly coupled to the container or containers to allow passage of a liquid from the water management device to the container or containers.

4. The apparatus of claim 2 or 3, wherein each of the plurality of containers is coupled to a respective duct.

5. The apparatus of claim 2, wherein the duct is coupled to two or more of the plurality of containers.

6. The apparatus of any previous claim, further comprising an auxiliary liquid reservoir mountable to a side of the water management device and configured to provide a store of liquid, in use.

7. The apparatus of claim 6 wherein the duct is coupled to the auxiliary liquid reservoir and configured to allow passage of liquid from the auxiliary liquid reservoir to the container or containers.

8. The apparatus of any previous claim, wherein the duct comprises a tube.

9. The apparatus of any previous claim, further comprising a metering device in the duct for restricting passage of liquid from the water management device to the container.

10. The apparatus of claim 9, wherein the metering device comprises a valve.

11. The apparatus of claim 9, wherein the metering device comprises a semi-permeable membrane.

12. The apparatus of any preceding claim, further comprising mounting means adapted to mount the container to the water management device.

13. The apparatus of any preceding claim wherein the water management device is a water butt and wherein the apparatus is mountable to the side of the water butt.

14. The apparatus of any one of claims 1 to 12 wherein the water management device is a rainwater down pipe and the apparatus is mountable to the side of the rainwater down pipe or between sections of the rainwater down pipe.

15. The apparatus of claim 13, when dependent on claim 6 and wherein the water management device is a water butt, wherein the auxiliary liquid reservoir is configured to provide a separate store of liquid from the primary liquid store of the water butt, in use.

16. The apparatus of claim 13 or claim 15 and wherein the water management device is a water butt, wherein the mounting means is adapted to hook over a lip of the water butt.

17. A water butt comprising:
an interior volume for storing liquid;
a container suitable for holding one or more plants, disposed on a side of the water butt; and
a duct coupled between the interior volume of the water butt and the container, and configured to allow passage of liquid from the interior volume to the container.

18. The water butt of claim 17, wherein the duct comprises a tube between the interior volume and the container.

19. The water butt of claim 17 or 18, further comprising a metering device in the duct for restricting passage of liquid from the interior volume to the container.

20. The water butt of claim 19, wherein the metering device comprises a valve.

21. The water butt of claim 20, wherein the metering device comprises a semi-permeable membrane.

22. The water butt of any of claims 17 to 21, further comprising an auxiliary liquid reservoir disposed about the interior of the water butt, and configured to provide a separate store of liquid from the primary liquid store of the water butt.

23. The water butt of claim 22, wherein the auxiliary liquid reservoir is integral to the water butt.

24. The water butt of claim 22, wherein the auxiliary liquid reservoir is removably connectable to the water butt.

25. The water butt of any of claims 17 to 22, wherein the container is integral to the water butt.

26. The water butt of any of claims 17 to 24, wherein the container is removably connectable to the water butt.

27. An apparatus mountable to a side of a water management device for storing liquid, the apparatus comprising:
a container suitable for holding liquid; and
a duct, coupled to the container and configured to allow passage of liquid from the container to enable liquid to be received therefrom.

28. The apparatus of claim 27, wherein the duct comprises a tube.

29. The apparatus of claim 27 or 28, further comprising a metering device in the duct for restricting passage of liquid from the water management device to the container.

30. The apparatus of claim 29, wherein the metering device comprises a valve.

31. The apparatus of claim 29, wherein the metering device comprises a semi-permeable membrane.

32. The apparatus of any of claims 27 to 31, further comprising mounting means adapted to mount the container to the water management device.

33. The apparatus of any of claims 27 to 32 wherein the water management device is one of a water butt and a rainwater down pipe.

34. The apparatus of claim 33, wherein the water management device is a water butt and wherein the apparatus provides a separate store of liquid from the primary liquid store of the water butt, in use.

35. The apparatus of claim 33 or 34 and wherein the water management device is a water butt, wherein the mounting means is adapted to hook over a lip of the water butt.

36. A water butt comprising
a first liquid reservoir; and
a second liquid reservoir separate from the first.

37. The water butt of claim 36, wherein the second reservoir is higher than the first reservoir, in use.

38. The water butt of claim 37, comprising a water pump for pumping liquid from the first reservoir to the second reservoir.

39. The water butt of any of claims 36 to 38, further comprising means for collecting rainwater.

40. The water butt of claim 39, wherein the means for collecting rainwater is adapted to direct the collected rainwater into each of the first and second liquid reservoirs.

41. The water butt of any of claims 36 to 40, wherein the water butt further comprises a drainage point for each of the first and second liquid reservoirs.

42. The water butt of claim 38, wherein the pump is powered by renewable energy.

43. An apparatus substantially as described herein, with reference to and as shown in the accompanying drawings.
